(19) United States
(12) Patent Application Publication
(10) Pub. No.: US 2024/0087788 A1
(43) Pub. Date: Mar. 14, 2024

(54) Choke Module and Method of Manufacturing a Choke Module

(71) Applicants: TDK Europe GmbH, München (DE); TDK Electronics AG, München (DE)

(72) Inventors: Shinichiro Nishizawa, München (DE); Martin Lauersdorf, Knittlingen (DE); Michael Rottner, Unterhaching (DE)

(21) Appl. No.: 18/261,644

(22) PCT Filed: Dec. 10, 2021
(86) PCT No.: PCT/EP2021/085243

§ 371 Date: Jul. 14, 2023

(30) Foreign Application Priority Data
Dec. 11, 2020 (DE) 10 2020 133 161.4

(51) Int. Cl. H01F 17/06; H01F 27/02; H01F 27/28; H01G 4/40

(52) U.S. Cl. CPC H01F 17/062; H01F 27/027; H01F 27/2895; H01G 4/40; H01F 2017/0093

(57) ABSTRACT

A choke module having a choke that includes a magnetic core and at least one winding and a support having a capacitor plate. The plate includes at least one first electrode layer, at least one second electrode layer, and at least one dielectric layer. The choke is located on the capacitor plate.

The present invention is directed to a choke module, in particular an EMC-filter module for reducing electromagnetic interference noise. The choke module may comprise a common mode choke. Such a common mode choke comprises two or more windings around a magnetic core. The windings may comprises metallic wires. The material of the wires, the core and the number of winding turns defines electrical parameters like inductance, losses and EMC noise attenuation. Generally, increasing the number of turns in the windings leads to an improvement of noise attenuation characteristics, at least in low frequency ranges. However, noise attenuation levels in high frequency ranges from 10 MHz to 1000 MHz, for example, are diminished due to parasitic capacitance effects between the windings. These parasitic capacitances effects increase proportional with the number of turns in the windings and with increasing the frequency.

EMC-filters (EMC: electromagnetic compatibility) are widely used for reducing noise in electric and electronic products, power electronic product such as inverters and DC-DC converters. In EMC-Filters, a common mode choke is electrically connected with passive components providing inductance, capacitance, resistance and combinations thereof, depending on the frequency characteristics of the passive components, to achieve an optimum and maximum in filtering effects and attenuation of the EMC noise level. Application areas are the automotive field, in particular autonomous driving systems with low voltage components and all forms of electric vehicles (xEV) with high voltage components, industrial products and the field of consumer products. EMC-filter chokes are usually interconnected in an EMC filter circuit with one or more capacitors in order to improve the damping properties at high frequency.

It is known to mount discrete capacitor components next to the choke on a printed circuit board. Furthermore, U.S. Pat. No. 10,644,588 B2 discloses an EMC filter module in which a choke is disposed between two mounting boards, wherein capacitors are disposed on the mounting boards. The mounting boards are arranged perpendicular to a main board and electrically connected to the main board. JP 2006-238310 A discloses a common mode choke in which an inductor and capacitors are integrally formed. JP 2019-198033 discloses a common mode choke assembled with a film capacitor.

It is an object of the present invention to provide an improved choke module.

In one aspect, the present invention relates to a choke module comprising a choke and a support on which the choke is located. The choke may comprise a magnetic core and at least one windings. In particular, the choke may comprise two or more windings. The choke may be a common mode choke for reducing electromagnetic interference noise.

The support comprises a capacitor plate, which comprises at least one first electrode layer, at least one second electrode layer and at least one dielectric layer arranged between the first and second electrode layers. The layers are arranged one above the other. In particular, the layers are stacked in a longitudinal direction. The longitudinal direction may be the same direction as the direction of mounting the choke assembly on a printed circuit board.

The choke is located on the capacitor plate. The capacitor plate may be formed by a printed circuit board. As an example, the capacitor plate may be formed by an FR4-board, a flexible board or a low temperature co-fired ceramics board, which are based on glass reinforced epoxy laminate, synthetic material and ceramics, respectively.

The first and second electrode layers may be formed by screen printing on the insulating dielectric layer and/or etching a metallic layer, such as a copper layer, located on the insulating dielectric layer. The first and second electrodes may comprise copper or consist of copper.

The support and the capacitor plate may have an overall shape of a plate. A plate generally has a small thickness and much larger lateral dimensions. As an example, the smallest lateral dimension may be at least five times larger than the thickness of the plate.

The choke module may be configure to the mounted on a printed circuit board with main surfaces of the capacitor plate and the printed circuit board parallel to each other. A mounting direction is perpendicular to the main surface of the printed circuit board. The choke module may be configured to be mounted on a printed circuit board such that the capacitor plate is located between the choke and the printed circuit board.

The capacitor plate may comprise one or more capacitors being interconnected with the choke between an input line and ground and/or an output line and ground. In particular, the filter circuit may be a so-called π-filter circuit.

The choke module with the integrated capacitor plate may provide high attenuation in radio bands, in a frequency range of 1 to 1000 MHz, for example. Furthermore, adjusting the capacitance value by adjusting the area and number of layers of the capacitor plate, improves the attenuation in specific frequency ranges within the range of 1 to 1000 MHz. In addition to that, low DC resistance and inductance can be achieved with the capacitor plate. This has advantages for noise reduction in high frequency ranges, compared to discrete capacitors such as film and ceramic capacitors, which have higher DC resistance and inductance values than commonly used in standard EMC filters.

The first electrode layer of the capacitor plate may comprise several first electrodes not electrically connected to each other. The first electrodes may be electrically connected to input and/or output ends of a choke winding. The wire endings may be directly electrically connected to the first electrodes or may be connected by an additional wiring to the first electrodes. Terminals may extend from the first electrodes downwards.

The second electrode layer may comprise a single electrode. The second electrode layer may be configured to be connected to ground. As an example, a terminal may extend from the second electrode layer downwards. The terminal may be a pin-type terminal.

The dielectric layer between the first and second electrode layer may be a continuous, single dielectric layer. Accordingly, several capacitors are formed by the separated first electrodes interacting with a common dielectric layer and a common second electrode layer.

The choke module may be configured to be placed on a further printed circuit board, such as a main board. On the printed circuit board other passive and/or active components and/or modules may be located. The terminals connected to the first and second electrodes may be configured to be soldered to the further printed circuit board. As an example, the terminals may be attached by pin-through hole mounting.

By such an arrangement, a miniaturization of the filter can be achieved. In particular, the choke module comprises the capacitor plate as a pre-assembled part. Due to the location of the choke on the capacitor plate, the lateral dimensions of the choke assembly are not increased when compared to a known choke assemblies where a choke is positioned on a fixation plate. Thus, additional space for a capacitor is not required on a printed circuit board and, thus a miniaturization can be achieved.

As an example, the surface area of the support may be not larger than ten times the surface area of the choke in a view on a main surface of the support. As an example, the surface area may be not larger than two times the surface area of the choke. Additionally or alternatively, the lateral dimension of the surface area of the support in any direction may be not larger than ten times the lateral dimension of the choke in the same direction in a view on a main surface of the support. As an example, the lateral dimensions may be not more than two times larger. The support may be solely provided for supporting the choke but may not support further electric components.

In an embodiment, the capacitor module may be free from an additional support plate between the choke and the capacitor plate. In this case, the choke may be directly fixed to the capacitor plate. It is also possible that the support comprises a fixation element which fixes the choke on the capacitor plate. Thus, the capacitor plate may replace a conventional support plate supporting the choke.

In an embodiment, the support may comprise an additional support plate located between the capacitor plate and the choke. The support plate may comprise a plastic material. The support plate may not have and electric functionality but merely supports the choke. The capacitor plate may be fixed to the support plate by gluing, for example. In such an embodiment, a choke supported on a plastic support may be retrofitted by a capacitor plate.

Input and output ends of choke windings may be guided through the support plate. The support plate may alternatively comprise integrated terminals connected to the input and output ends. The terminals may be guided through holes in the capacitor plate. In particular, the choke may comprise four terminals, wherein each of the terminals is guided through a hole in the capacitor plate.

A further aspect of the present invention specifies a use of the choke module described in the foregoing. In particular, the choke module is used for reducing electromagnetic interference noise. The choke module may be used as a common mode choke module.

A further aspect of the present invention relates to a method for manufacturing the choke module described in the foregoing. In the method, a choke and a capacitor plate is provided and the choke is arranged on the capacitor plate. In an embodiment, the choke may be located on a support plate and the capacitor plate may be arranged on a bottom side of the support plate. The bottom side is opposite to a top side on which the choke is located.

A further aspect of the present invention relates to an assembly comprising the choke module described in the foregoing and a printed circuit board, wherein the choke module is mounted on the printed circuit board. In this case, main surfaces of the capacitor plate and the printed circuit board are arranged parallel to each other. Terminals of the choke module may be fixed to pads of the printed circuit board by pin-through-hole technology, for example. It is also possible to solder a second electrode layer at the bottom of the choke module directly to pads of the printed circuit board.

The present disclosure comprises several aspects of an invention. Every feature described with respect to one of the aspects is also disclosed herein with respect to the other aspect, even if the respective feature is not explicitly mentioned in the context of the specific aspect.

Further features, refinements and expediencies become apparent from the following description of the exemplary embodiments in connection with the figures.

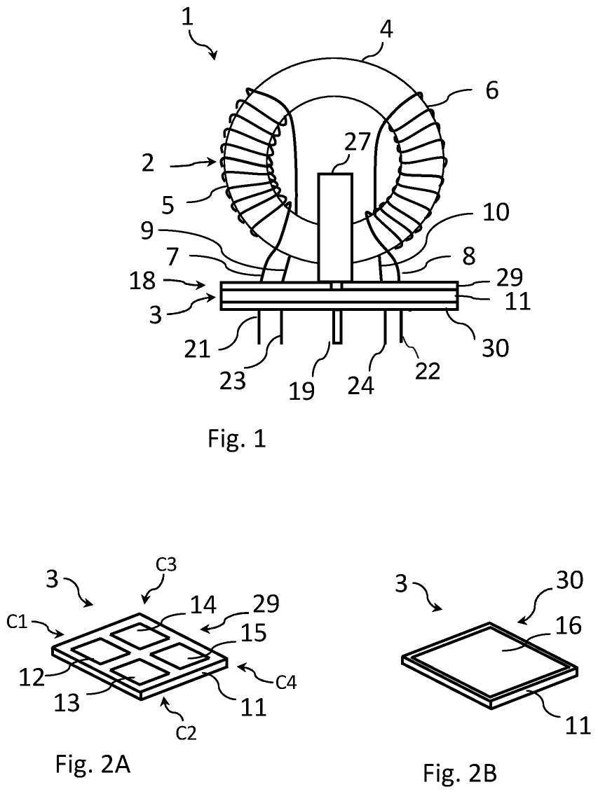

FIG. 1 shows an embodiment of a choke module in a schematic side view,

FIG. 2A shows an embodiment of a capacitor plate of a choke module in a top view,

FIG. 2B shows the capacitor plate of FIG. 2A in a bottom view,

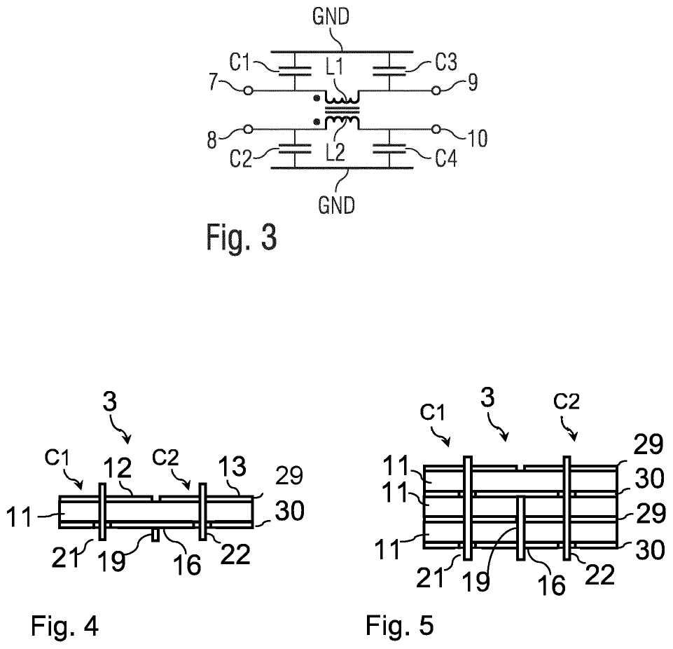

FIG. 3 shows a circuit diagram of an embodiment of a choke module,

FIG. 4 shows a capacitor plate with a single dielectric layer in a sectional view,

FIG. 5 shows a capacitor plate with three dielectric layers in a sectional view,

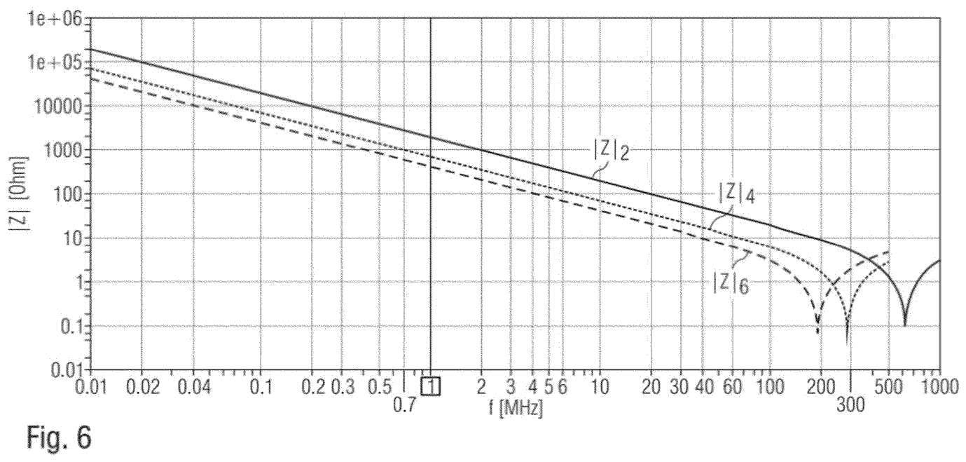

FIG. 6 shows diagrams of an absolute value of impedance over frequency for different capacitor plates,

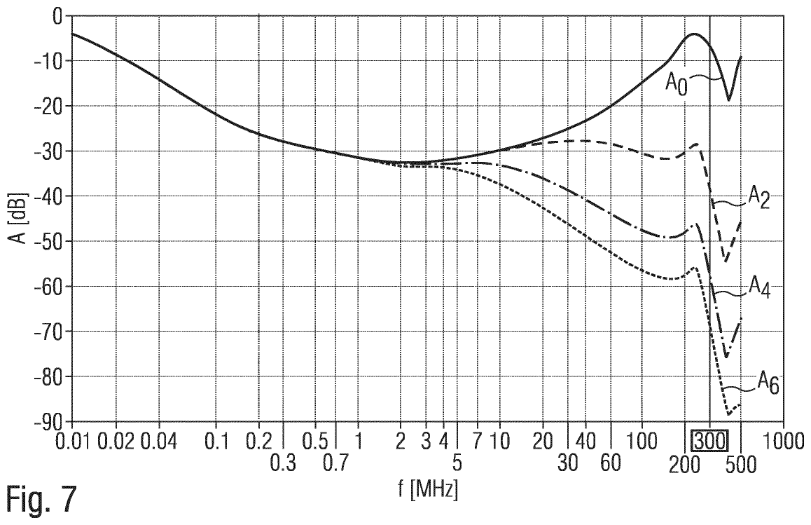

FIG. 7 shows diagrams of attenuation over frequency for different capacitor plates,

FIG. 8 shows an embodiment of an assembly of a choke module and a printed circuit board in a schematic side view,

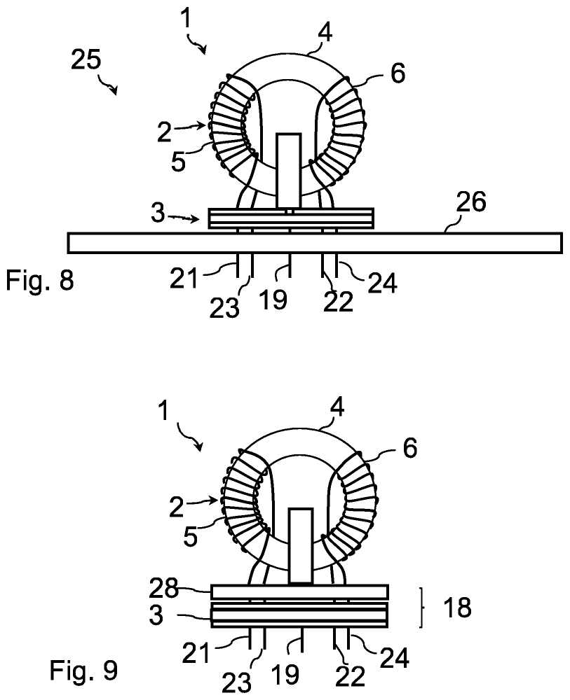

FIG. 9 shows a further embodiment of a choke module in a schematic side view.

In the figures, elements of the same structure and/or functionality may be referenced by the same reference numerals. It is to be understood that the embodiments shown in the figures are illustrative and are not necessarily drawn to scale.

FIG. 1 shows an embodiment of a choke module 1 comprising a choke 2 located on a support 18. The support is formed as a capacitor plate 3.

The choke 2 is a common mode choke for reducing electromagnetic interference noise, for example. In particular, the choke 2 serves as a filter for providing electromagnetic compatibility (EMC).

The choke 2 comprises a magnetic core 4 and two windings 5, 6 on the core 4. Each of the windings 5, 6 has an input end 7, 8 and an output end 9, 10. The input signal is provided to the input ends 7, 8 and the filtered output signal is provided at the output ends 9, 10. Terminals 21-24 may be connected to the input ends 7-10. The terminals 21-24 may be pin-shaped and fixed to a printed circuit board by pin-through-hole mounting, for example. A further terminal 19 may be configured to be connected to ground.

The capacitor plate 3 supports the choke 2. As an example, the core 4 or the windings 5, 6 may be directly located on the capacitor plate 3. The choke 2 may be additionally or alternatively supported on the capacitor plate 3 by ends 7-10 of the windings 5, 6 being fixed to the capacitor plate 3.

The lateral dimensions of the capacitor plate 3 are not much larger than the lateral dimensions of the choke 2. The thickness of the capacitor plate 3 is much smaller than the length and width of the capacitor plate 3.

A fixation element 27 may fix the choke 2 on the capacitor plate 3. The fixation element 27 may be attached to the capacitor plate 3 by snap-fitting, for example. The fixation element 27 may also be an integral part of the capacitor plate 3. The choke 2 may be fixed to the fixation element 27 by snap-fitting, for example.

The capacitor plate 3 has not only a support functionality but also a capacitor functionality. In particular, the capacitor plate 3 comprises a dielectric layer 11 sandwiched between a first electrode layer 29 and a second electrode layer 30. The dielectric layer 11 and the electrodes 12-16 form one or mora capacitors. The first electrode layer 29 may comprise several separate electrodes 12, 13, 14, 15 and the second electrode layer may comprise a single second electrode 16 (see FIGS. 2A, 2B).

The dielectric layer 11 may comprise or consist a plastic material. The dielectric layer 11 may comprise or consist of an epoxy resin. In particular, the dielectric layer 11 may comprise or consist of an FR4-material. The capacitor plate 3 may be a printed circuit board.

The electrodes 12-16 may be conductive plates fixed to the dielectric layer 11. The electrodes 12-16 may be also applied to the dielectric layer 11 by screen printing and/or galvanic processes. The electrodes 12-16 may comprise or consist of copper.

In the shown choke module 1, the choke 2 is vertically mounted. In other embodiments, the choke 2 may be horizontally mounted.

FIG. 2A shows a capacitor plate 3 in a top view and FIG. 2B shows the capacitor plate 3 in a bottom view. The capacitor plate 3 may be the capacitor plate 3 as shown in FIG. 1.

As can be seen in FIG. 2A, the first electrode layer 29 comprises four first electrodes 12-15 formed as four separate regions on the upper side of the dielectric layer 11. In particular, each of the first electrodes 12-15 has a rectangular, in particular quadratic, shape. The shape can be also circular to improve the high frequency noise reduction in radio band ranges. In particular, the shape of the entire support 18 and the capacitor plate 3 can be circular. In this case, also the shape of the first and second electrode layers 29, 30 and the dielectric layer 11 is circular. The first electrodes 12-15 may have the shape of quarter circles. Furthermore, the total area of the four electrodes 12-15 and the gaps between the four electrodes 12-15 can be smaller than the single second layer 16 in the FIG. 2B. This improves the noise reduction in the high frequency ranges. The first electrodes 12-15 are arranged as two rows and two columns on the dielectric layer 11.

Each of the input ends and output ends 7-10 is electrically connected to one of the first electrodes 12-15. In particular, the input ends 7, 8 are connected to adjacent first electrodes 12, 13 in a first row. The output ends 9, 10 are connected to adjacent first electrodes 14, 15 in a second row. Depending on the number of input and output ends 7-10, the number of first electrodes 12-15 may be different. Depending on the specific circuitry, it is also possible to connect several input ends and output ends to the same first electrode. Overall, the first electrodes 12-15 are the footprint pattern of the capacitor plate 3, matching the input ends 7, 8 and output ends 9, 10 of the choke 2. In other words, the capacitor plate 3 is a footprint plate capacitor.

The first electrodes 12-15 cover the top surface of the dielectric layer 11 almost entirely, apart from the insulating gaps between the first electrodes 12-15 and small insulating regions on the lateral edges of the top surface. The first electrodes 12-15 may also extend to the very edges of the top surface such that the insulating regions on the lateral edges may not be present.

As can be seen in FIG. 2B, the second electrode layer 30 has a single second electrode 16 with a rectangular, in particular a quadratic, shape. The second electrode 16 covers almost the entire bottom surface of the dielectric layer 11, apart from small insulating regions on the lateral edges of the bottom surface. The second electrode 16 may also extend to the very edges of the bottom surface such that the insulating regions on the lateral edges may not be present.

The capacitor plate 3 may have a shape different than the shown rectangular shape. As an example, the capacitor plate 3 may have a circular shape. The shapes of the electrodes 12-16 are adapted to the shape of the capacitor plate 3.

The second electrode 16 may be connected to ground. In particular, the second electrode 16 may be connected by a pin or an electric wire to a mass contact of a circuit board, for example. The second electrode 16 may be also directly connected to the circuit board, in particular to a mass pad of the circuit board.

The capacitor values of the capacitors formed by the capacitor plate 3 can be varied by varying the surface area of the dielectric layer and/or the surface areas of the electrodes 12-16. Furthermore, the capacitor plate 3 may have a multilayer configuration. In this case, the capacitor plate 3 may comprise several layers of dielectric layers and electrodes layers arranged one above the other.

The outer dimensions of the choke module may be similar to the outer dimensions of a choke module comprising a usual support plate. Thus, replacing the support plate by the shown capacitor plate 3 with capacitor functionality does not lead to an increase of the size of the choke module.

FIG. 3 shows a diagram of a filter circuit 20. In particular, the choke module 1 of FIG. 1 may be connected according to the filter circuit 20.

The input ends 7, 8 are connected via an inductance L1, L2 provided by the windings 5, 6 to the output ends 9, 10. Four capacitors C1, C2, C3, C4 are provided by the first electrodes 12-15, the dielectric layer 11 and the second electrode 16. First capacitors C1, C2 are connected at the input side between an input line and ground. The second capacitors C3, C4 are connected at the output side between an output line and ground. Such capacitor connected between input or output line and ground are so-called Y-capacitors.

The shown filter circuit 20 is a π-filter circuit for each of the lines. However, the choke 2 and capacitor plate 3 may be also interconnected to form a different circuit.

FIGS. 4 and 5 show cross-sectional views of capacitor plates 3 having different layered structures and their electrical connection structures.

FIG. 4 shows a capacitor plate 3 with a single dielectric layer 11. The first input terminals 21, 22, which may be the input ends 7, 8 of the first and second windings 5, 6, respectively, or which may be a pin or through connection electrically connected to the input ends 7, 8, are in electrical contact with the first electrodes 12, 13 and extend downwards through the second electrode 16 while being insulated from the second electrode 16. The bottom layer 30 may be covered by a dielectric layer or a different insulation material to provide electric insulation. Also the uppermost electrode layer 29 may be covered by a dielectric layer or a different insulation material.

A corresponding connection structure applies for the output terminals 23, 24 which are not visible in this view. The output terminals 23, 24 are connected or integral with output ends 9, 10 of the windings 5, 6, and the first electrodes 14, 15 and the second electrode 16.

A ground terminal 19 is electrically connected with the second electrode 16 and extends downwards.

FIG. 5 shows a capacitor plate 3 with four electrode layers 29, 30 and three dielectric layers 11 arranged between the electrode layers. In particular, the electrode layers 29, 30 are alternately configured as first electrodes 29 and second electrodes 30. The first input terminals 21, 22 are in electrical contact with the first electrodes 12, 13 and extend downwards through the second electrodes 16 while being insulated from the second electrodes 16. A corresponding connection structure applies for the output terminals 23, 24 not visible in this view.

A ground terminal 19 is electrically connected to the second electrode 16 and extends downwards.

The capacitor plate 3 may comprise more dielectric layers 11 and electrode layers 12-16. As an example, a capacitor plate 3 may comprise five dielectric layers 11 and six electrode layers 29, 30.

FIG. 6 shows diagrams of the absolute values of impedance |Z| over frequency f for choke assemblies 1 similar to the embodiment of FIG. 1, for capacitor plates 3 with two electrode layers 12-16 (curve |Z|₂), four electrode layers 12-16 (curve |Z|₄) and six electrode layers (curve |Z|₆), respectively. The diagrams result from simulations, wherein the input ends 7, 8 are electrically connected to each other and the output ends 9, 10 are electrically connected to each other.

Each of the dielectric layers 11 has a thickness of 0.3 mm. The dielectric layers 11 and electrode layers 29, 30 are printed circuit boards of the FR4-type.

The simulation results in the following values for capacitance C, inductance L and resistance R in an equivalent circuit model at a frequency of 1 MHz:
two electrode layers: C=79 pF, L=0.8 nH, R=110 mOhm, |Z|=2009.30 Ohm; resonance frequency at 620 MHz
four electrode layers: C=234 pF, L=1.37 nH, R=75 mOhm, |Z|=680.43 Ohm; resonance frequency at 281 MHz
six electrode layers: C=388 pF, L=1.65 nH, R=75 mOhm, |Z|=409.44 Ohm; resonance frequency at 190 MHz

The choke modules 1 thus show a low DC resistance and inductance. Additional discrete Y-capacitors for high frequencies are not required.

FIG. 7 shows diagrams of attenuation A over frequency f for choke assemblies 1 similar to the embodiment of FIG. 1 for capacitor plates 3 with two electrode layers 12-16 (curve A₂) four electrode layers 12-16 (curve A₄) and six electrode layers (curve A₆), respectively. The curves result from a simulation with the same parameters as for FIG. 6. As a comparative example, also the attenuation A₀ for a choke module without a capacitor plate is depicted.

As can be clearly seen, at high frequencies, the absolute value of attenuation increases with an increasing number of electrode layers 29, 30.

The simulation results in the following values for attenuation at a frequency of 300 MHz:
without capacitor plate: A₀=−6.93 dB
two electrode layers: A₂=−38.81 dB
four electrode layers: A₄=−57.62 dB
six electrode layers: A₆=−68.47 dB

Generally, a high attenuation in radio band ranges can be achieved. The simulations results of FIGS. 6 and 7 have been confirmed by comparative measurements.

FIG. 8 shows an assembly 25 of a choke module 1 and a printed circuit board 26, such as a main board. The printed circuit board 26 has a larger surface area than the capacitor plate 3 of the choke module 1. Further electric components may be located on the main board 26. However, a miniaturization is achieved because of the capacitor plate 3 being located between the choke 1 and the main board 26. Accordingly, a further discrete capacitor for the filter circuit has not to be placed on the main board 26. Accordingly, a further discrete capacitor for filtering noise at radio frequency ranges, has not to be placed in the area of input or output connectors of main board 26.

FIG. 9 shows a further embodiment of a choke module 1. In difference to the embodiment of FIG. 1, the support 18 comprises not only the capacitor plate 3 but also an additional support plate 28.

The support plate 28 does not have a capacitor functionality. The support plate 28 may be a standard support for a choke 2. The capacitor plate 3 has the same lateral dimensions as the support plate 28. The capacitor plate 3 may be also larger or smaller than the support plate 28.

This embodiment simplifies the manufacture of the choke module 1. In particular, a standard choke 2 located on a support plate 28 can be provided and then the capacitor plate 3 can be attached at the bottom side of the support plate 28. The capacitor plate 3 may comprise holes through which the terminals 21-25 are inserted. The ground terminal 19 may be pre-attached to the capacitor plate 3.

### REFERENCE NUMERALS

1 choke module
2 choke
3 capacitor plate
4 core
5 winding
6 winding
7 input end
8 input end
9 output end
10 output end
11 dielectric layer
12 first electrode
13 first electrode
14 first electrode
15 first electrode
16 second electrode
17 terminal
18 support
19 ground terminal
20 filter circuit
21 first input terminal
22 second input terminal
23 first output terminal
24 second output terminal
25 assembly
26 printed circuit board
27 fixation element
28 support plate
29 first electrode layer
30 second electrode layer
C1, C2, C3, C4 capacitor
L1, L2 inductance
GND Ground
   |Z| absolute value of impedance
A attenuation
f frequency

1. A choke module, comprising:
a choke comprising a magnetic core and at least one winding; and
a support comprising a capacitor plate, the capacitor plate comprising at least one first electrode layer, at least one dielectric layer and at least one second electrode layer (30) located one above the other, wherein the choke is located on the capacitor plate.

2. The choke module of claim 1, wherein the capacitor plate is formed from printed circuit board comprising one or more dielectric layers.

3. The choke module of claim 2, wherein the printed circuit board is of an FR4-type.

4. The choke module of claim 1, wherein the choke comprises four terminals, wherein each of the terminals is guided through a hole in the capacitor plate.

5. The choke module of claim 1, being configured to be mounted on a printed circuit board such that main surfaces of the capacitor plate and the printed circuit board are parallel to each other.

6. The choke module of claim 1, wherein a surface area of the support is not larger than ten times a surface area of the choke in a view on a main surface of the support.

7. The choke module of claim 1, being free from an additional support plate arranged between the choke and the capacitor plate.

8. The choke module of claim 1, wherein the support comprises an additional support plate and a capacitor plate, wherein the support plate is located between the choke and the capacitor plate.

9. The choke module of claim 8, wherein the additional support plate comprises a plastic material and has no electronic functionality.

10. The choke module of claim 1, wherein the first electrode layer comprises four separate first electrodes and the second electrode layer comprises a single second electrode.

11. The choke module of claim 1, being configured as a common mode choke for reducing electromagnetic interference noise.

12. The choke module of claim 1, wherein the capacitor plate comprises several first electrode layers, several second electrode layers and several dielectric layers.

13. A use of the choke module of claim 1 for reducing electromagnetic interference noise.

14. A method for manufacturing a choke module of claim 1, the method comprising the step of:
providing a choke and a capacitor plate and arranging the choke on the capacitor plate.

15. The method for manufacturing the choke module of claim 14, wherein the choke is located on a support plate and wherein the capacitor plate is located on a bottom side of the support plate.

16. An assembly comprising the choke module of claim 1 and a printed circuit board, wherein the choke module is mounted on the printed circuit board.

17. The assembly of claim 16, wherein the choke module comprises terminals connected to first and second electrodes of the first and second electrode layers, wherein the terminals are connected to the printed circuit board by pin-through-hole technology.

18. The assembly of claim 16, wherein main surfaces of the capacitor plate and the printed circuit board are parallel to each other.

19. The assembly of claim 16, wherein the choke module is mounted on the printed circuit board and the capacitor plate is located between the choke and the printed circuit board.

20. The assembly of claim 16, wherein the first electrode layer comprises at least two first electrodes, each of the first electrodes being electrically connected to an input or output end of the choke winding.
